(19) United States
(12) Patent Application Publication
(10) Pub. No.: US 2021/0148428 A1
(43) Pub. Date: May 20, 2021

(54) VIBRATION ISOLATOR

(71) Applicant: NOK CORPORATION, Tokyo (JP)

(72) Inventors: Takeshi WATANABE, Fukushima (JP); Yuki HANADA, Kanagawa (JP)

(73) Assignee: NOK CORPORATION, Tokyo (JP)

(21) Appl. No.: 17/036,530

(22) Filed: Sep. 29, 2020

(30) Foreign Application Priority Data
Nov. 14, 2019 (JP) 2019-206406

(51) Int. Cl. F16F 1/373; F16F 1/377

(52) U.S. Cl. CPC F16F 1/3737; F16F 2230/36; F16F 2230/30; F16F 1/377

(57) ABSTRACT

A vibration isolator includes: a vibration isolation member including a metal plate as a plate-shaped member, and an upper rubber layer and a lower rubber layer deposited on a top surface and a bottom surface of the metal plate; an insertion hole through which a fastening member for attaching the vibration isolation member to a sealing target, the insertion hole being provided on an outer peripheral side of the vibration isolation member; and a vibration isolation bead portion provided in at least part of a surrounding area around the insertion hole in the vibration isolation member.

### BACKGROUND

### Technical Field

The disclosure relates to a vibration isolator.

### Related Art

Conventionally, a gasket using so-called rubber coated metal (hereinafter also referred to as RCM) configured such that both surfaces of a metal plate are coated with a rubber material has been widely used. As such a gasket, for example, there has been known a gasket constituted by a compound layer and a seal ring layer, the compound layer being formed by mixing a fiber material into synthetic resin or a rubber material and integrally laminated on each surface of an annular metal substrate, the seal ring layer being made of synthetic resin or a rubber material and integrally deposited on a pressed layer formed such that an inner peripheral part of the compound layer is compressed in its thickness direction with a given width (for example, see International Publication No. 2008/065857).

### SUMMARY

### Problem to be Solved

In the meantime, in recent years, various demands for vehicles such as automobiles have been raised by users. Particularly, a demand for silence is growing and remains to be solved in terms of not only internal combustion engines but also electrical equipment units (a motor, an inverter, a converter, a PCU (Power Control Unit), and so on). Further, silence has been demanded for the gasket described above. The conventional gasket described above is made of a steel sheet the central part of which is thick, and its vibration and sound isolation function is small. Further, it is difficult to secure a sufficient assembling space in such a conventional gasket, and therefore, it is difficult to use a vibration isolating rubber or the like for the conventional gasket. On this account, the conventional gasket is demanded to have a structure that can improve vibration isolation and sound isolation to vibrations in vehicles or the like.

The disclosure is accomplished in view of the above problems, and an object of the disclosure is to provide a vibration isolator that can improve vibration isolation and sound isolation.

### Means for Solving the Problem

In order to achieve the above object, a vibration isolator according to the disclosure includes: a vibration isolation member including a plate-shaped member and respective rubber layers deposited on both surfaces of the plate-shaped member; an insertion hole through which a fastening member for attaching the vibration isolation member to a sealing target is passed through, the insertion hole being provided on an outer peripheral side of the vibration isolation member; and a vibration isolation bead portion provided in at least part of a surrounding area around the insertion hole in the vibration isolation member.

In the vibration isolator according to one aspect of the disclosure, the vibration isolation bead portion is provided to be placed below a screw head in a usage state, the screw head being provided in one end of the fastening member.

In the vibration isolator according to one aspect of the disclosure, the vibration isolation bead portion is provided to be placed below the screw head and in an end portion, on the outer peripheral side, of the vibration isolation member in the usage state.

In the vibration isolator according to one aspect of the disclosure, the vibration isolation bead portion is provided to surround a whole circumference of the insertion hole.

The vibration isolator according to one aspect of the disclosure includes: an opening provided in a central part of the vibration isolation member such that the opening penetrates through both surfaces of the vibration isolation member; and a sealing bead portion provided on an outer peripheral side of the opening.

### Effect

With the vibration isolator of the disclosure, it is possible to improve vibration isolation and sound isolation.

### BRIEF DESCRIPTION OF THE DRAWINGS

FIG. 1 is a front view illustrating a schematic configuration of a vibration isolator according to a first embodiment of the disclosure.

FIG. 2 is a sectional view of the vibration isolator taken along a line A-A in

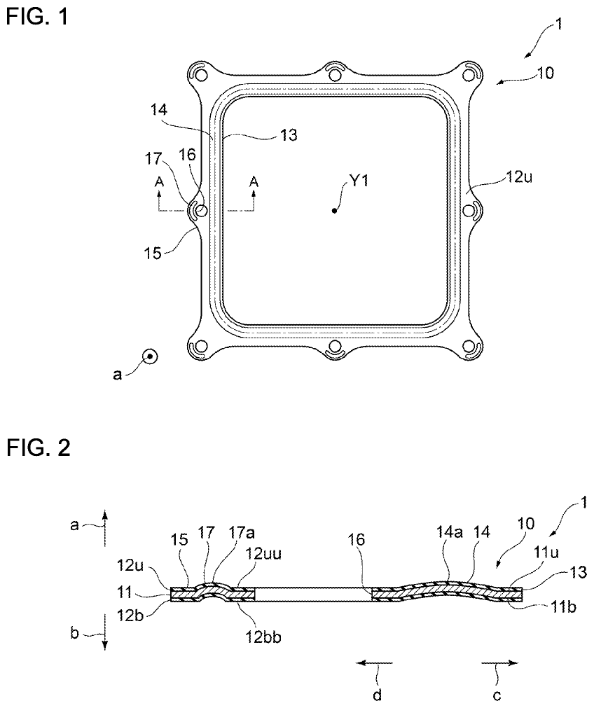

FIG. 1.

FIG. 3 is a sectional view taken along the line A-A to illustrate a usage state of the vibration isolator illustrated in FIG. 1.

FIG. 4 is a sectional view illustrating a first reference example of a fastening state between a first housing and a second housing via a bolt.

FIG. 5 is a front view illustrating a schematic configuration of a vibration isolator according to a second embodiment of the disclosure.

FIG. 6 is a sectional view of the vibration isolator taken along a line B-B in FIG. 5.

FIG. 7 is a sectional view of the vibration isolator taken along a line C-C in FIG. 5.

FIG. 8 is a sectional view take along the line B-B to illustrate a usage state of the vibration isolator illustrated in FIG. 5.

FIG. 9 is a sectional view take along the line C-C to illustrate a usage state of the vibration isolator illustrated in FIG. 5.

FIG. 10 is a sectional view illustrating a second reference example of a fastening state between a first housing and a second housing via a bolt.

### DESCRIPTION OF THE EMBODIMENTS

Embodiments of the disclosure will be described with reference to the drawings.

### First Embodiment

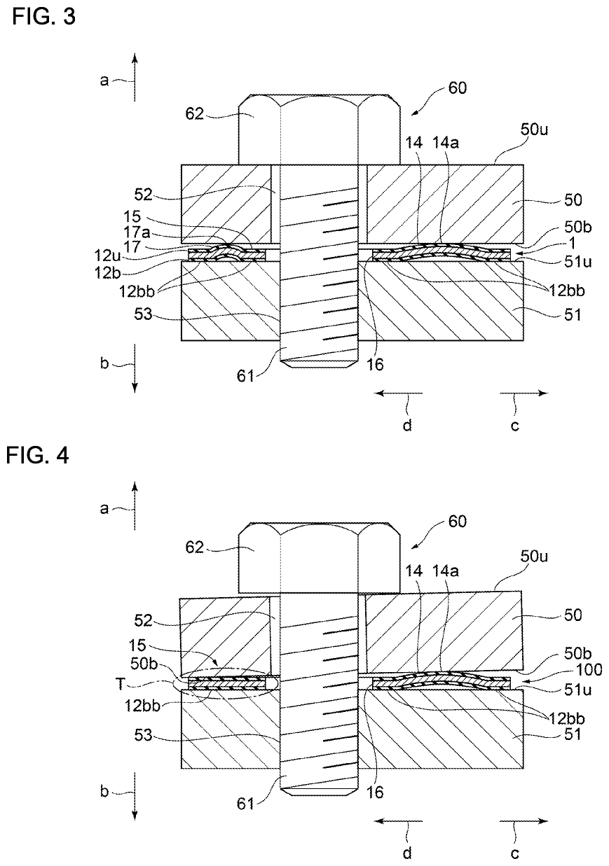

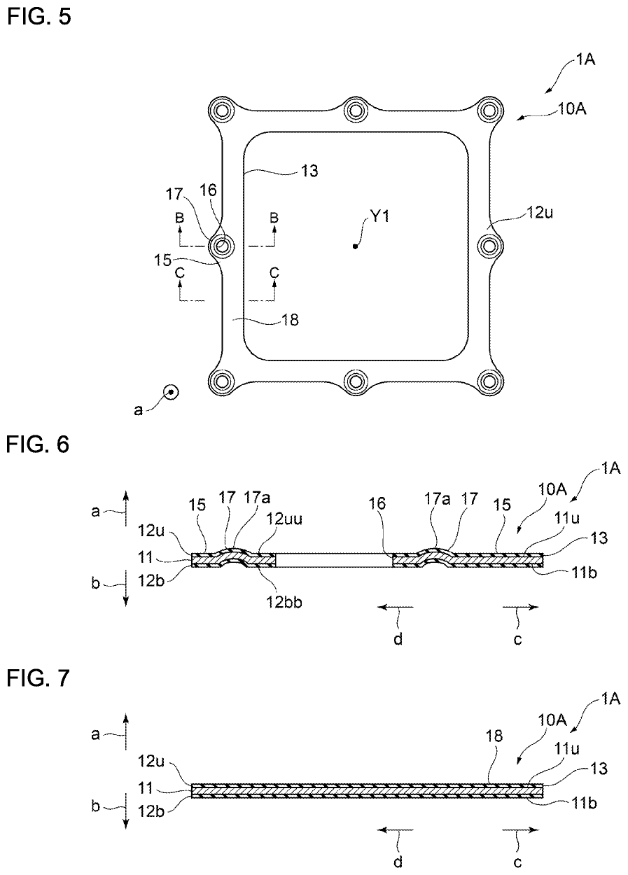

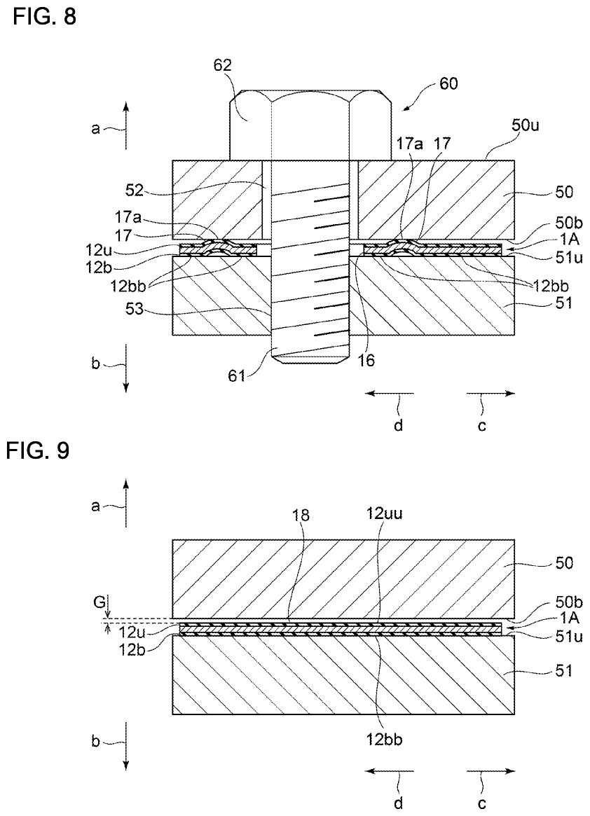

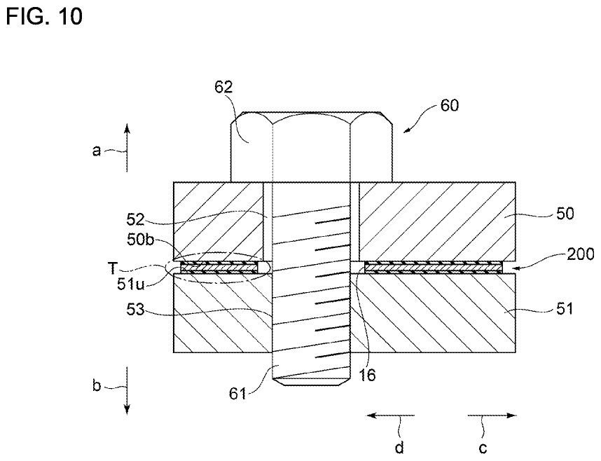

FIG. 1 is a front view illustrating a schematic configuration of a vibration isolator 1 according to a first embodiment of the disclosure. Further, FIG. 2 is a sectional view of the vibration isolator 1 taken along a line A-A.

In the following description, for purpose of this description, in the direction (hereinafter also referred to as an axis direction) of an axis Y1 that is the axis of the vibration isolator 1 in FIGS. 1 and 2, a first side (the direction of an arrow a) is taken as an upper side, and a second side (the direction of an arrow b) is taken as a lower side. Further, in a radial direction extending perpendicularly to the axis Y1 of the vibration isolator 1 in FIGS. 1 and 2, a first side (the direction of an arrow c) is taken as an inner peripheral side, and a second side (the direction of an arrow d) is taken as an outer peripheral side. In the following description, when a positional relationship between members or a direction of each member is described by use of the upper side or the lower side, it indicates a positional relationship or a direction only on the drawings and does not indicate a positional relationship or a direction when the members are assembled to an actual vehicle or the like.

The vibration isolator 1 serves as a gasket for sealing a gap between two members of various types such as a joined portion as a space between a cylinder block and a cylinder head of an internal combustion engine as sealing targets, a joined portion between an exhaust manifold and an exhaust pipe, or electrical equipment units (a motor, an inverter, a converter, a PCU, or the like), for example. Note that a target to which the vibration isolator 1 is applied is not limited to the above members.

As illustrated in FIGS. 1 and 2, the vibration isolator 1 includes: a vibration isolation member 10 including a metal plate 11 as a plate-shaped member and rubber layers (an upper rubber layer 12u, a lower rubber layer 12b) deposited on both surfaces (a top surface 11u, a bottom surface 11b) of the metal plate 11; an insertion hole 16 through which a fastening member for attaching the vibration isolation member 10 to sealing targets, the insertion hole 16 being provided on the outer peripheral side of the vibration isolation member 10; and a vibration isolation bead portion 17 provided in at least part of a surrounding area around the insertion hole 16 in the vibration isolation member 10. The following describes the configuration of the vibration isolator 1 in detail.

In a usage state of the vibration isolator 1, one of the two members as the sealing targets in a vehicle such as an automobile, e.g., a cylinder head or the like of an internal combustion engine, is placed on the upper side (the direction of the arrow a) of the vibration isolator 1. Further, in the usage state of the vibration isolator 1, the other one of the two members as the sealing targets in the vehicle such as an automobile, e.g., a cylinder block or the like of the internal combustion engine, is placed on the lower side (the direction of the arrow b) of the vibration isolator 1. The usage state of the vibration isolator 1 will be described later.

In the vibration isolator 1, as illustrated in FIG. 1, the vibration isolation member 10 has an outer shape formed in a square shape with rounded corners and has an opening 13 in its central part, the opening 13 being a square-shaped through-hole with rounded corners. That is, the vibration isolation member 10 is formed in an annular shape as a whole. The vibration isolation member 10 is provided with a plurality of bolt receiving portions 15 (eight bolt receiving portions 15 in FIG. 1) having a generally semicircular shape and projecting toward the outer peripheral side (the direction of the arrow d) from an outer peripheral surface of the vibration isolation member 10. The bolt receiving portions 15 have respective insertion holes 16 through which respective fastening members are passed, as illustrated in FIG. 1.

The vibration isolation member 10 is rubber coated metal (hereinafter also referred to as RCM). That is, as illustrated in FIG. 2, the vibration isolation member 10 includes the metal plate 11, the upper rubber layer 12u deposited on the top surface 11u as a surface, on the upper side (the direction of the arrow a), of the metal plate 11, and the lower rubber layer 12b deposited on the bottom surface 11b as a surface, on the lower side (the direction of the arrow b), of the metal plate 11.

The metal plate 11 is made of, for example, a steel sheet, a stainless steel, a cold rolled steel sheet, a galvanized steel sheet, an aluminum composite panel, or the like. The upper rubber layer 12u and the lower rubber layer 12b are made of, for example, synthetic rubber (including expanded rubber) or the like including at least one of nitrile rubber, styrene butadiene rubber, fluororubber, acrylic rubber, and silicon rubber. Further, the plate-shaped member in the disclosure may be a member made of hard resin or the like other than a member made of metal such as the metal plate 11 in the present embodiment.

The metal plate 11 includes a sealing bead portion 14 provided over the whole circumference of the opening 13 and having a projecting shape in which a first surface, more specifically, the top surface 11u projects upward (toward the direction of the arrow a). The sealing bead portion 14 is formed in a full bead shape having an arc shape in a sectional view such that the central part of the metal plate 11, for example, in the width direction (the directions of the arrows c and d) swells from the lower side (the direction of the arrow b) toward the upper side (the direction of the arrow a) with a top portion 14a being taken as a top portion in the axis direction (the directions of the arrows a and b). That is, the vibration isolator 1 in which the sealing bead portion 14 is formed in the metal plate 11 has a floating structure.

The bolt receiving portions 15 each include the vibration isolation bead portion 17 having a semi-arc shape in a front view such that the vibration isolation bead portion 17 is formed in at least part of the surrounding area around the insertion hole 16, more specifically, on the outer peripheral side (the direction of the arrow d) of the insertion hole 16. The vibration isolation bead portion 17 has a projecting shape in which the first surface, more specifically, the top surface 11u projects upward (the direction of the arrow a). The vibration isolation bead portion 17 is formed in a full bead shape having an arc shape in a sectional view such that, in the central part of the bolt receiving portion 15 in the width direction (the directions of the arrows c and d), for example, the vibration isolation bead portion 17 swells from the lower side (the direction of the arrow b) toward the upper side (the direction of the arrow a) with a top portion 17a being taken as a top portion in the axis direction (the directions of the arrows a and b). That is, the vibration isolator 1 in which the vibration isolation bead portion 17 is formed in the bolt receiving portion 15 has a floating structure.

Next will be described the usage state of the vibration isolator 1.

FIG. 3 is a sectional view take along a line A-A to illustrate the usage state of the vibration isolator 1. As illustrated in FIG. 3, in the usage state of the vibration isolator 1, one of the two members as the sealing targets in the vehicle such as an automobile, e.g., a first housing 50 constituted by the cylinder head or the like of the internal combustion engine, is placed on the upper side (the direction of the arrow a) of the vibration isolator 1. The first housing 50 has a bolt insertion hole 52 having a diameter that allows a male screw portion 61 of a bolt 60 to pass through the bolt insertion hole 52. The bolt insertion hole 52 is formed at the same position as the insertion hole 16 of the bolt receiving portion 15 in the axis direction (the direction of the arrow a or b). In FIG. 3, the other one of the two members as the sealing targets in the vehicle such as an automobile, e.g., a second housing 51 constituted by the cylinder block or the like of the internal combustion engine, is placed on the lower side (the direction of the arrow b) of the vibration isolator 1. The second housing 51 includes a female screw portion 53 as a threaded hole having a diameter and a thread shape that allow the female screw portion 53 to threadedly engage to the male screw portion 61 of the bolt 60. The female screw portion 53 is formed at the same position as the bolt insertion hole 52 of the first housing 50 and the insertion hole 16 of the bolt receiving portion 15 in the axis direction (the direction of the arrow a or b).

The inner peripheral sides (the direction of the arrow c) of the first housing 50 and the second housing 51 are inner parts of the cylinder head and the cylinder block of the internal combustion engine, for example, and correspond to a sealing target side of the vibration isolator 1.

In FIG. 3, the vibration isolator 1 is provided between the first housing 50 and the second housing 51. In this state, the male screw portion 61 of the bolt 60 is passed through the bolt insertion hole 52 from the upper side of the first housing 50 toward the lower side thereof, and the male screw portion 61 threadedly engages to the female screw portion 53 of the second housing 51. Further, in the bolt 60, a screw head 62 provided in one end of the male screw portion 61 abuts with a top surface 50u that is a surface, on the upper side (the direction of the arrow a), of the first housing 50. The bolt receiving portion 15 of the vibration isolator 1 and the vibration isolation bead portion 17 provided in the bolt receiving portion 15 are provided below (the direction of the arrow b) the screw head 62 of the bolt 60.

In the usage state illustrated in FIG. 3, a bottom surface 12bb of the lower rubber layer 12b of the vibration isolator 1 abuts with a top surface 51u of the second housing 51. Further, in this state, the top portion 14a of the sealing bead portion 14 of the vibration isolator 1 abuts with a bottom surface 50b that is a surface, on the lower side (the direction of the arrow b), of the first housing 50. As such, in the vibration isolator 1, the bottom surface 12bb of the lower rubber layer 12b abuts with the top surface 51u of the second housing 51, and the top portion 14a of the sealing bead portion 14 abuts with the bottom surface 50b of the first housing 50, so that the sealing bead portion 14 can elastically deform and seal the sealing target sides of the first housing 50 and the second housing 51.

FIG. 4 is a sectional view illustrating a first reference example of a fastening state between the first housing 50 and the second housing 51 via the bolt 60. FIG. 4 is different from the example of the usage state of the vibration isolator 1 in the present embodiment illustrated in FIGS. 2 and 3 in that a vibration isolator 100 of a reference example is placed between the first housing 50 and the second housing 51 instead of the vibration isolator 1. The vibration isolator 100 of the reference example is not provided with the vibration isolation bead portion 17 in the surrounding area around the insertion hole 16 in the bolt receiving portion 15.

As illustrated in FIG. 4, in the state of the reference example, when either or both of the first housing 50 and the second housing 51 vibrate, respective metallic materials of the first housing 50 and the second housing 51 make direct contact with each other between the bottom surface 50b of the first housing 50 and the top surface 51u of the second housing 51, e.g., in a region T including outer end portions of the first housing 50 and the second housing 51, surrounded by a broken line in FIG. 4, because the vibration isolator 100 that does not include the vibration isolation bead portions 17 is placed between the first housing 50 and the second housing 51. As a result, in a joined portion between the first housing 50 and the second housing 51, noise occurs because of the contact between the metallic materials.

Generally, machine components for automobiles or the like, e.g., the first housing 50 and the second housing 51 as targets to be fastened and the bolt 60 as a fastening member, are made of metal such as aluminum alloy, magnesium alloy, iron alloy, or the like and easily transmit vibrations to each other.

In the meantime, in the usage state illustrated in FIG. 3 in which the vibration isolator 1 is provided between the first housing 50 and the second housing 51, the bottom surface 12bb of the lower rubber layer 12b in the surrounding area around the insertion hole 16 in the bolt receiving portion 15 of the vibration isolator 1 abuts with the top surface 51u of the second housing 51 below the screw head 62 of the bolt 60. Further, in the surrounding area around the insertion hole 16 of the vibration isolator 1, the top portion 17a of the vibration isolation bead portion 17 abuts with the bottom surface 50b that is the surface, on the lower side (the direction of the arrow b), of the first housing 50. More specifically, the vibration isolation bead portion 17 of the vibration isolator 1 is provided to be placed below the screw head 62 in the usage state. As such, in the surrounding area around the insertion hole 16 in the bolt receiving portion 15 of the vibration isolator 1, the bottom surface 12bb of the lower rubber layer 12b abuts with the top surface 51u of the second housing 51, and the top portion 17a of the vibration isolation bead portion 17 abuts with the bottom surface 50b of the first housing 50, so that the vibration isolation bead portion 17 elastically deforms. Here, it is desirable that, in the usage state, the vibration isolation bead portion 17 be provided below the screw head 62 and placed in an end portion, on the outer peripheral side (the direction of the arrow d), of the vibration isolation member 10. With such a configuration, in the vibration isolator 1, the vibration isolation bead portion 17 elastically deforms, thereby preventing the first housing 50 and the second housing 51 from making contact with each other around the region T illustrated in the reference example in FIG. 4, the first housing 50 being provided on the upper side of the vibration isolator 1, the second housing 51 being provided on the lower side of the vibration isolator 1. Accordingly, with the vibration isolator 1, it is possible to prevent vibration and noise caused due to the contact between the first housing 50 and the second housing 51 and transmission from a source of vibration.

Further, in the vibration isolator 1 according to the first embodiment of the disclosure, the top surface 12uu of the upper rubber layer 12u abuts with the bottom surface 50b of the first housing 50, and the bottom surface 12bb of the lower rubber layer 12b abuts with the top surface 51u of the second housing 51, so that damping performance of rubber can be obtained. On this account, with the vibration isolator 1, it is possible to further improve vibration isolation and sound isolation to vibrations in vehicles such as automobiles.

### Second Embodiment

Next will be described a vibration isolator 1A according to a second embodiment of the disclosure. In the following description, a constituent having a function equal or similar to that of a constituent of the vibration isolator 1 according to the first embodiment has the same reference sign as the constituent of the vibration isolator 1, and a redundant description thereof is omitted. The following describes only constituents different from the first embodiment.

FIG. 5 is a front view illustrating a schematic configuration of the vibration isolator 1A according to the second embodiment of the disclosure. Further, FIG. 6 is a sectional view of the vibration isolator 1A taken along a line B-B. Further, FIG. 7 is a sectional view of the vibration isolator 1A taken along a line C-C. As illustrated in FIGS. 5 to 7, the vibration isolator 1A according to the present embodiment is different from the vibration isolator 1 described above in that the sealing bead portion 14 is not provided around the opening 13 of the vibration isolation member 10A, and respective vibration isolation bead portions 17 provided around the insertion holes 16 in the bolt receiving portions 15 have a shape different from that in the first embodiment.

As illustrated in FIGS. 5 to 7, the vibration isolator 1A does not include the sealing bead portion 14 around the opening 13 of the vibration isolation member 10. Accordingly, the upper rubber layer 12u is provided on the top surface 11u of the metal plate 11 having flat surfaces, and the lower rubber layer 12b is provided on the bottom surface 11b thereof. The vibration isolator 1A includes a flat portion 18 having a flat surface that does not have a sealing function (a function as a gasket) between inside and outside for a first housing placed on the upper side (the direction of the arrow a) of the vibration isolator 1A and a second housing placed on the lower side (the direction of the arrow b) of the vibration isolator 1A in a usage state of the vibration isolator 1A. That is, at the time when two members of various types are joined by being fastened by a fastening member such as a bolt or a screw, the vibration isolator 1A is provided between a gap between the fastening member and a target to be fastened by the fastening member so that the vibration isolator 1A functions to restrain vibrations caused between the fastening member and the target to be fastened.

Subsequently, the shape of the vibration isolation bead portion 17 of the present embodiment is different from the shape of the vibration isolation bead portion 17 of the vibration isolator 1 described above, more specifically, in that the vibration isolation bead portion 17 of the present embodiment has a round shape in a front view as illustrated in FIG. 5. That is, in the vibration isolator 1A, the vibration isolation bead portion 17 is provided to surround the outer periphery of the insertion hole 16.

As illustrated in FIG. 6, in the vibration isolator 1A, the vibration isolation bead portion 17 is also formed in a projecting shape in which the first surface, more specifically, the top surface 11u projects upward (toward the direction of the arrow a). More specifically, the vibration isolation bead portion 17 is formed in a full bead shape having an arc shape in a sectional view such that, in the central part of the bolt receiving portion 15 in the width direction (the directions of the arrows c and d), for example, the vibration isolation bead portion 17 swells from the lower side (the direction of the arrow b) toward the upper side (the direction of the arrow a) with the top portion 17a being taken as a top portion in the axis direction (the directions of the arrows a and b). That is, the vibration isolator 1A in which the vibration isolation bead portion 17 is formed in the bolt receiving portion 15 has a floating structure.

Next will be described the usage state of the vibration isolator 1A.

FIG. 8 is a sectional view take along a line B-B to illustrate the usage state of the vibration isolator 1A. Further, FIG. 9 is a sectional view take along a line C-C to illustrate the usage state of the vibration isolator 1A. As illustrated in FIGS. 8 and 9, in the usage state of the vibration isolator 1A, one of two members as sealing targets in a vehicle such as an automobile, e.g., the first housing 50 constituted by a cylinder head or the like of an internal combustion engine, is placed on the upper side (the direction of the arrow a) of the vibration isolator 1A. The first housing 50 has the bolt insertion hole 52 having a diameter that allows the male screw portion 61 of the bolt 60 to pass through the bolt insertion hole 52. The bolt insertion hole 52 is formed at the same position as the insertion hole 16 of the bolt receiving portion 15 in the axis direction (the direction of the arrow a or b). In FIGS. 8 and 9, the other one of the two members as the sealing targets in the vehicle such as an automobile, e.g., the second housing 51 constituted by a cylinder block or the like of the internal combustion engine, is placed on the lower side (the direction of the arrow b) of the vibration isolator 1A. The second housing 51 includes the female screw portion 53 as a thread hole having a diameter and a thread shape that allow the female screw portion 53 to threadedly engage to the male screw portion 61 of the bolt 60. The female screw portion 53 is formed at the same position as the bolt insertion hole 52 of the first housing 50 and the insertion hole 16 of the bolt receiving portion 15 in the axis direction (the direction of the arrow a or b).

In FIGS. 8 and 9, the vibration isolator 1A is provided between the first housing 50 and the second housing 51. In this state, the male screw portion 61 of the bolt 60 is passed through the bolt insertion hole 52 from the upper side of the first housing 50 toward the lower side thereof, and the male screw portion 61 threadedly engages to the female screw portion 53 of the second housing 51.

FIG. 10 is a sectional view illustrating a second reference example of the fastening state between the first housing 50 and the second housing 51 via the bolt 60. FIG. 10 is different from the example of the usage state of the vibration isolator 1A in the present embodiment illustrated in FIGS. 8 and 9 in that a vibration isolator 200 of a reference example is placed between the first housing 50 and the second housing 51 instead of the vibration isolator 1A, and the vibration isolator 200 does not include the vibration isolation bead portions 17.

As illustrated in FIG. 10, in the state of the reference example, when either or both of the first housing 50 and the second housing 51 vibrate, respective metallic materials of the first housing 50 and the second housing 51 make direct contact with each other between the bottom surface 50b of the first housing 50 and the top surface 51u of the second housing 51, e.g., in the region T including the outer end portions of the first housing 50 and the second housing 51, surrounded by a broken line in FIG. 10, because the vibration isolator 200 that does not include the vibration isolation bead portions 17 is placed between the first housing 50 and the second housing 51. As a result, in a joined portion between the first housing 50 and the second housing 51, noise occurs because of the contact between the metallic materials.

In the meantime, in the usage state illustrated in FIG. 8, the bottom surface 12bb of the lower rubber layer 12b in the surrounding area around the insertion hole 16 in the bolt receiving portion 15 of the vibration isolator 1A abuts with the top surface 51u of the second housing 51, below (the direction of the arrow b) the screw head 62 of the bolt 60. Further, in the surrounding area around the insertion hole 16 of the vibration isolator 1A, the top portion 17a of the vibration isolation bead portion 17 abuts with the bottom surface 50b that is the surface, on the lower side (the direction of the arrow b), of the first housing 50.

As illustrated in FIG. 9, between the first housing 50 and the second housing 51, in a part other than the bolt receiving portion 15, the part being not provided with the vibration isolation bead portion 17, there is a difference between the height of the vibration isolation bead portion 17, i.e., the dimension thereof in the axis direction (the directions of the arrows a and b) of the vibration isolator 1A, and the height of the flat portion 18 that does not include the vibration isolation bead portion 17. Here, in the usage state of the vibration isolator 1A, the difference in height between the first housing 50 and the second housing 51 is a gap G between the top surface 12uu of the upper rubber layer 12u of the vibration isolator 1A and the bottom surface 50b on the lower side of the first housing 50.

As illustrated in FIGS. 8 and 9, in the usage state of the vibration isolator 1A, the gap G is caused between the first housing 50 and the second housing 51, so that the first housing 50 and the second housing 51 are brought into a non-contact state. On this account, with the vibration isolator 1A, it is possible to prevent respective metallic materials constituting the first housing 50 and the second housing 51 from making contact with each other, thereby making it possible to isolate both vibration systems from each other. That is, with the vibration isolator 1A, it is possible to prevent transmission of vibration or noise from either or both of the first housing 50 and the second housing 51. Further, with the vibration isolator 1A, it is possible to prevent respective metallic materials constituting the first housing 50 and the second housing 51 from making contact with each other, thereby making it possible to further prevent occurrence of vibration or noise due to contact between the metallic materials and transmission from a vibration source.

The preferred embodiments of the disclosure have been described above, but the disclosure is not limited to the above embodiments and includes every aspect included in the concept of the disclosure and the scope of claims. Further, the configurations may be combined selectively appropriately to at least partially achieve the aforementioned object and effects. Further, for example, the shape, material, arrangement, size, and so on of each constituent in the above embodiments can be changed appropriately in accordance with a concrete usage aspect of the disclosure.

For example, in the disclosure, as the shape of the vibration isolation bead portion 17, a shape with the sealing bead portion 14 like the vibration isolator 1 or a shape surrounding the whole circumference of the insertion hole 16 like the vibration isolation bead portion 17 of the vibration isolator 1A may be employed. Further, the shape of the vibration isolation bead portion 17 may be a shape that does not include the sealing bead portion 14 provided in the vibration isolator 1 or a shape partially surrounding the outer peripheral side of the insertion hole 16 like the vibration isolation bead portion 17 of the vibration isolator 1. Further, the shape of the vibration isolation bead portion 17 is not limited to the above examples, provided that the vibration isolation bead portion 17 is provided in at least part of the surrounding area around the insertion hole 16 in the vibration isolation member 10.

### REFERENCE SIGNS LIST

1 . . . vibration isolator, 10 . . . vibration isolation member, 11 . . . metal plate, 11b . . . bottom surface, 11u . . . top surface, 12b . . . lower rubber layer, 12bb . . . bottom surface, 12u . . . upper rubber layer, 12uu . . . top surface, 13 . . . opening, 14 . . . sealing bead portion, 14a . . . top portion, 15 . . . bolt receiving portion, 16 . . . insertion hole, 17 . . . vibration isolation bead portion, 17a . . . top portion, 18 . . . flat portion, 50 . . . first housing, 50b . . . bottom surface, 50u . . . top surface, 51 . . . second housing, 51u . . . top surface, 52 . . . bolt insertion hole, 53 . . . female screw portion, 60 . . . bolt, 61 . . . male screw portion, 62 . . . screw head, Y1 . . . axis

1. A vibration isolator comprising:
a vibration isolation member including a plate-shaped member and respective rubber layers deposited on both surfaces of the plate-shaped member;
an insertion hole through which a fastening member for attaching the vibration isolation member to a sealing target is passed through, the insertion hole being provided on an outer peripheral side of the vibration isolation member; and
a vibration isolation bead portion provided in at least part of a surrounding area around the insertion hole in the vibration isolation member.

2. The vibration isolator according to claim 1, wherein the vibration isolation bead portion is provided to be placed below a screw head in a usage state, the screw head being provided in one end of the fastening member.

3. The vibration isolator according to claim 2, wherein the vibration isolation bead portion is provided to be placed below the screw head and in an end portion, on the outer peripheral side, of the vibration isolation member in the usage state.

4. The vibration isolator according to claim 1, wherein the vibration isolation bead portion is provided to surround a whole circumference of the insertion hole.

5. The vibration isolator according to claim 1 4, comprising:
an opening provided in a central part of the vibration isolation member such that the opening penetrates through both surfaces of the vibration isolation member; and
a sealing bead portion provided on an outer peripheral side of the opening.
